(19) United States
(12) Patent Application Publication
(10) Pub. No.: US 2011/0234539 A1
(43) Pub. Date: Sep. 29, 2011

(54) Device and Method of Identifying Position of Determinant via Combining Optical Image with Single Axis of Touch Panel

(76) Inventors: CHIH-HSUAN LIAO, Kaohsiung City (TW); YU-HSIANG CHENG, Kaohsiung City (TW); CHENG-HSUAN WANG, Kaohsiung City (TW)

(21) Appl. No.: 12/917,495

(22) Filed: Nov. 2, 2010

(30) Foreign Application Priority Data
Mar. 24, 2010 (TW) 099108797

(51) Int. Cl. G06F 3/042

(52) U.S. Cl. 345/175

(57) ABSTRACT

A device and method of identifying the position of a determinant via combining optical image with a single axis of touch panel includes sensing identification of any single axis via only one image sensor module provided at a side or outside the work area for retrieving images and combining with the identification device of the touch panel in the work area, then, calculating the relative position of the determinant through the triangulating relationship and the formula x×tan θ=y in response to retrieved images and identified information from the touch panel.

### BACKGROUND OF THE PRESENT INVENTION

1. Field of Invention

The present invention relates to a structure and method of identifying the position of a determinant, and more particularly to identifying the position of determinant via combining optical image with single axis of touch panel.

2. Description of Related Arts

A known optical image touch device, as shown in FIG. 1, has two projection cameras (21) (22) provided at a side edge (20) of a work area have two transmitters (21P) (22P) which form a triangulating relationship with a determinant (23), and the two projection cameras (21) (22), which separately have an image coincident area with the determinant (23), separately retrieve the coincident image (B) of the images (21A) (22A) for calculating the area of the coincident image (B) to identify the relative position of the determinant (23).

The identification uses projection cameras (21) (22) calculate the relative position of the determinant. The input device of the optical image type relatively not limited to the hardware space has a advantageous of having relatively large identification work area may be usually used to the putting equipment with large work area, such as electronic whiteboard, etc. But the imaging process wastes processor space, especially in the setting of the projection cameras. To cover the whole work area and retrieve effective image, three or four projection cameras should be set at the endpoints of the work area to retrieve the coincident image, otherwise there would be a projecting blind area (C). But this solution not only significantly increases the cost of setting the projection cameras, but also needs high level processor because of the increased calculation caused by the increased images and coincident images which need to be processed, which in turn may cause delay and mistakes in identification because of the increased calculation load.

### SUMMARY OF THE PRESENT INVENTION

A solution device identifying the position of determinant via combining optical image with single axis of touch panel, including: an image sensor module at the side edge of or outside a work area for retrieving images in the work area; a first touch panel in the work area, which is a low level touch panel with a single axis which a determinant locates; and a calculating unit: at least one ray from a transmitter of the image sensor module connecting with the axis, for calculating the location of the transmitter by triangulation using a projecting point, an intersection point of a sensing axis L0 and any ray, and a predetermined fiducial line.

The present invention includes a method of identifying the position of a determinant via combining optical image with single axis of touch panel, including: providing an image sensor module at the side edge of or outside the work area for retrieving images in the work area; providing a first touch panel in the work area, which is a low level touch panel with a single axis which a determinant locates; and providing a calculating unit: at least one ray from a transmitter of the image sensor module, the fiducial line, and the intersecting axis to form a triangle. The method includes using only one image sensor module provided at a side edge or outside the work area for retrieving images, and combining with the identification device of the low level touch panel in the work area to sense the identification of any single axis. The method then includes, calculating the relative position of the determinant in the work area through the triangulating relationship and the formula x×tan θ=y according to the retrieved images and the identified information from the first touch panel. The objects of the invention include:

1. the number of the image sensor module is reduced, and the device and its design is simplified to increase the competitive strength. Because of the direct identification mode, not only the calculation of the calculating unit is reduced, but also the accuracy and speed of the identification device are increased.

2. the present invention combines the optical image retrieve, so the identification device of the first low level touch panel not only increases the input accuracy of the determinant but also reduces the production cost.

These and other objectives, features, and advantages of the present invention will become apparent from the following detailed description, the accompanying drawings, and the appended claims.

### BRIEF DESCRIPTION OF THE DRAWINGS

FIG. 1 is a schematic of a device according to prior art.

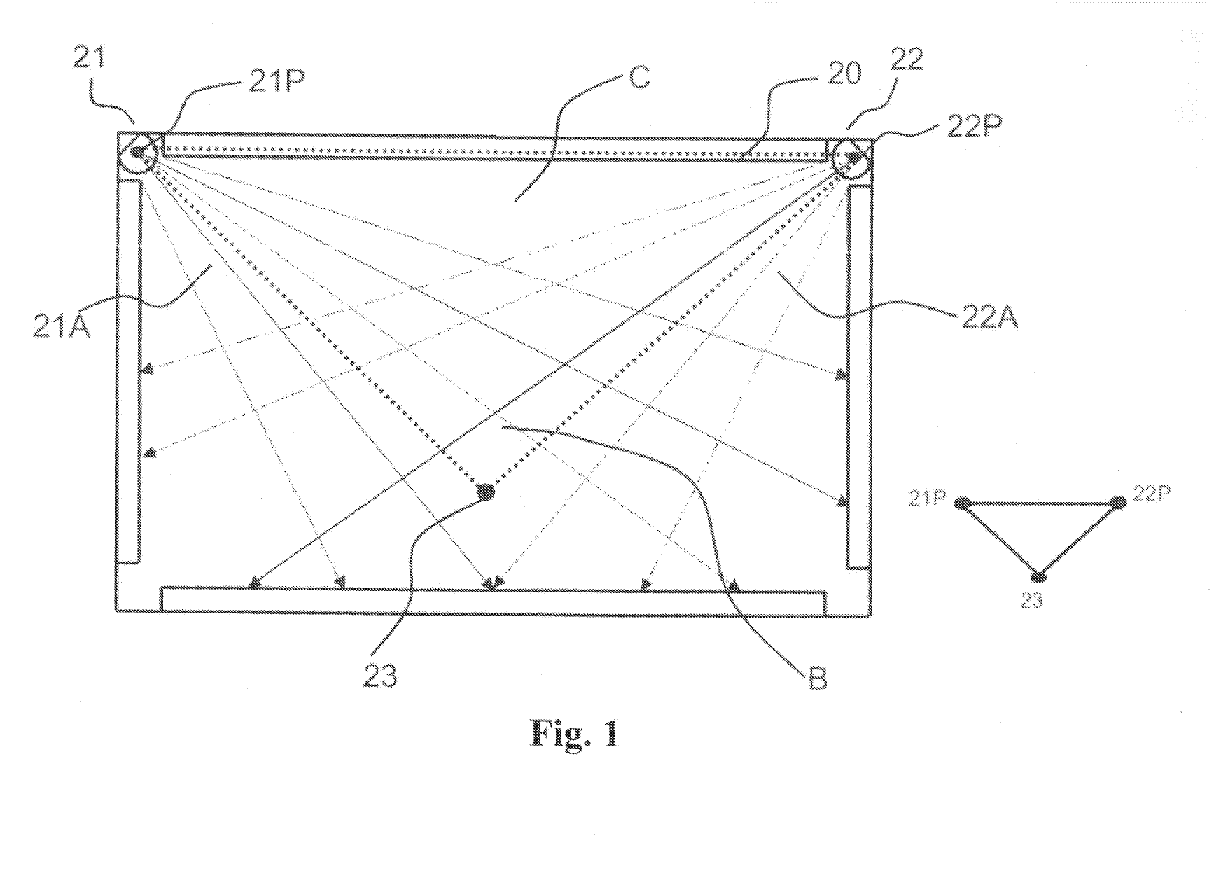

FIG. 2 is a schematic of a device according to the present invention.

FIG. 3 is a schematic of the device according to a first embodiment of the present invention.

FIG. 4 is a schematic of the device according to a second embodiment of the present invention.

FIG. 5 is a fundamental schematic of the principle and calculating formula of the present invention.

FIG. 6 is a fundamental schematic of the principle and calculating formula of the present invention.

FIG. 7 is a fundamental schematic of the principle and calculating formula of the present invention.

FIG. 8 is a fundamental schematic of the principle and calculating formula of the present invention.

FIG. 9 is a fundamental schematic of the principle and calculating formula of the present invention.

FIG. 10 is a schematic of related calculating principle of the present invention.

FIG. 11 is a flow diagram of the present invention.

### DETAILED DESCRIPTION OF THE PREFERRED EMBODIMENT

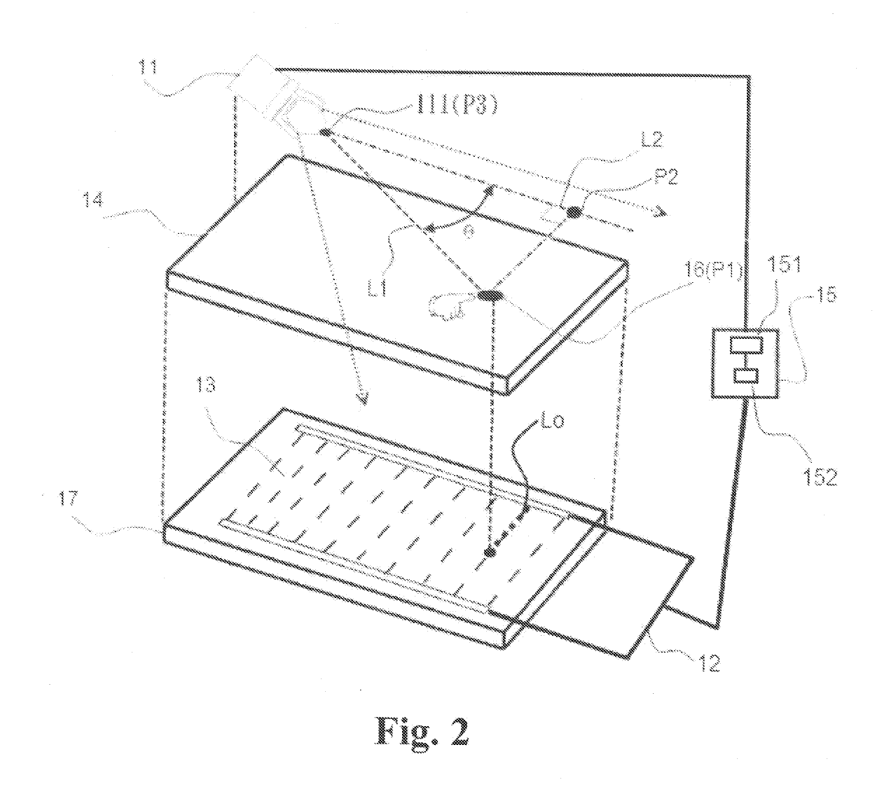

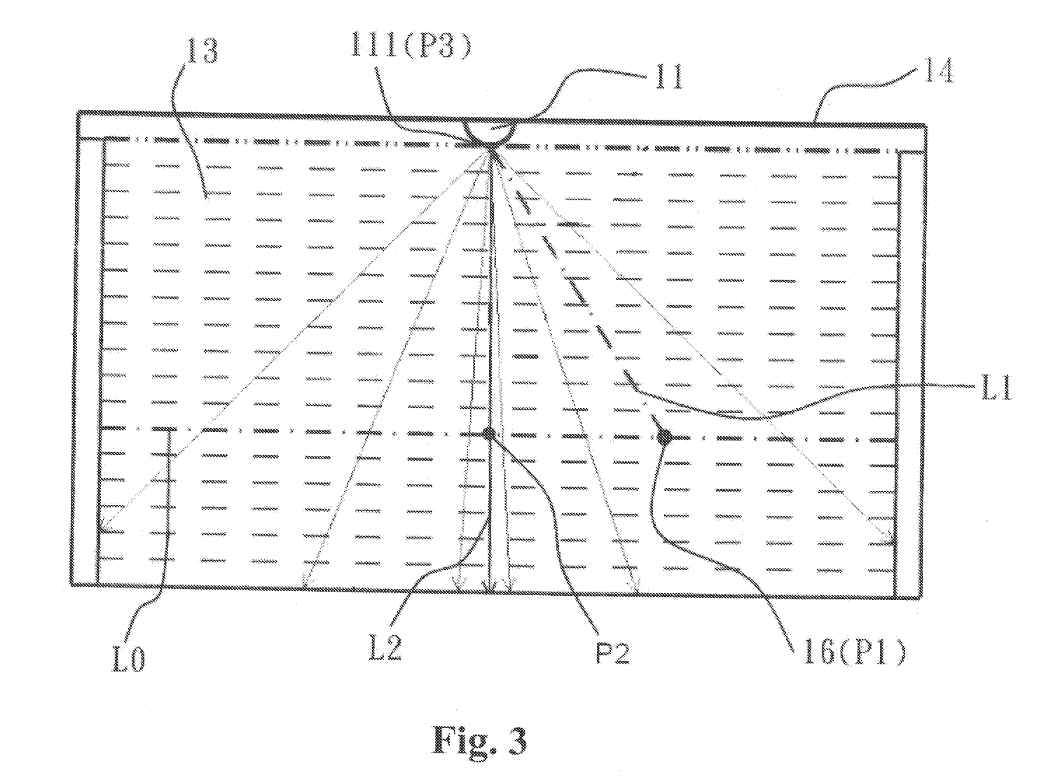

Referring to FIG. 2 to FIG. 3, the present invention relates to a device for identifying the position of a determinant via combining optical image with single axis of touch panel, including a step of providing an image sensor module (11) at the side of a work area (13) or outside the work area (13). The image sensor module (11) may be a CCD or CMOS image sensor module. And the image sensor module (11) may include a photographic lens.

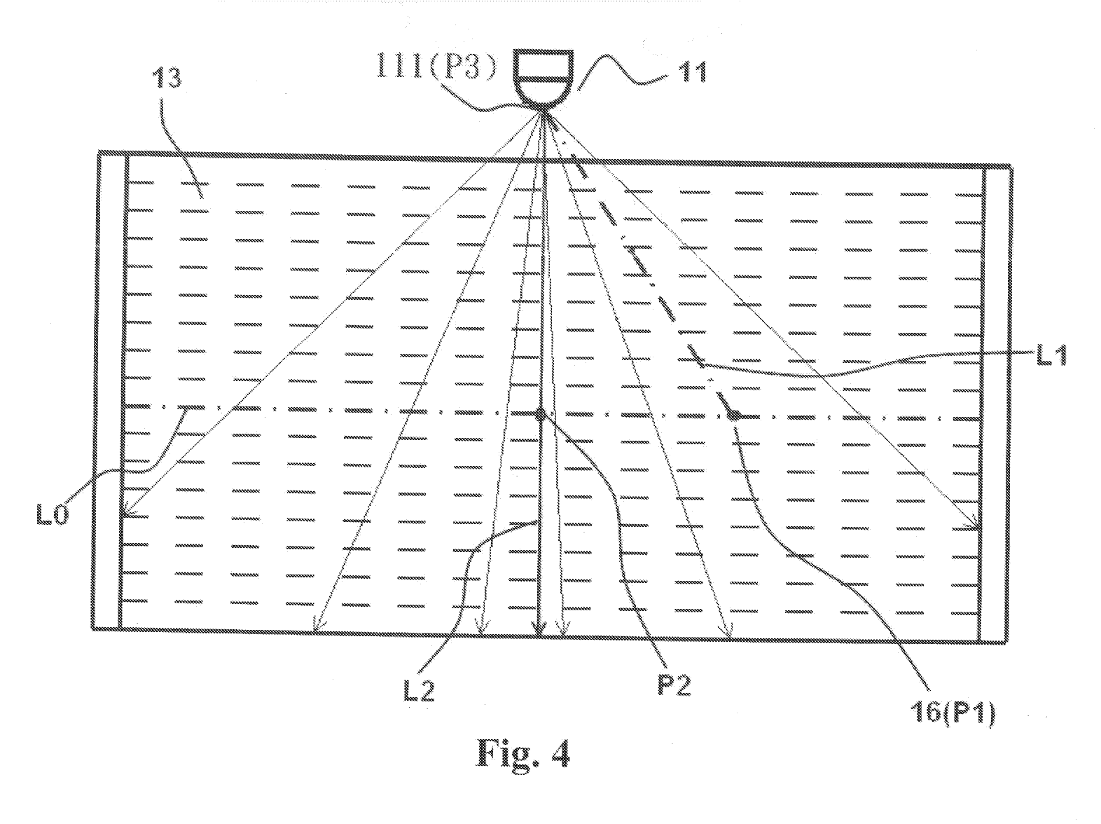

As shown in FIG. 4, the image sensor module (11) is connected for retrieving the images in the work area (13).

Referring to FIG. 3, a first touch panel (14) is provided in the work area (13), being a low level touch panel with a single axis for detecting an axis (L0) which a determinant (16) locates, wherein the single axis (L0) is even one axis taken from two axes (X-axis and Y-axis crisscrossing to identify the input coordinate), so fewer axes may reduce cost.

A calculating unit (15) includes a circuit board (151) electrically connected to an image sensor unit (152). The image sensor unit (152) may electrically connect to the image sensor module (11), or circuit board (151). At least one ray (L1) from a transmitter (111) of the image sensor module (11), a predetermined fiducial line (L2), and the axis (L0) intersect to form three points (P1) (P2) (P3) to form a triangle. Only one image sensor module (11) is provided at the side of the work area (13) or outside the work area (13) for retrieving images and combines with the identification device of the first touch panel (14) with relatively low level in the work area (13) to sense the identification of any axis. The next step is to calculate the relative position of the determinant (16) in the work area and the location of the determinant (16) through the triangulating relationship and the formula x×tan θ=y combining with the retrieved information and the identified information of the first touch panel.

A second touch panel (17) at the bottom of the work area (13) for senses pressure when the determinant (16) pressing connects to the first touch panel (14) via a connecting line (12) to achieve synchronous induction and output.

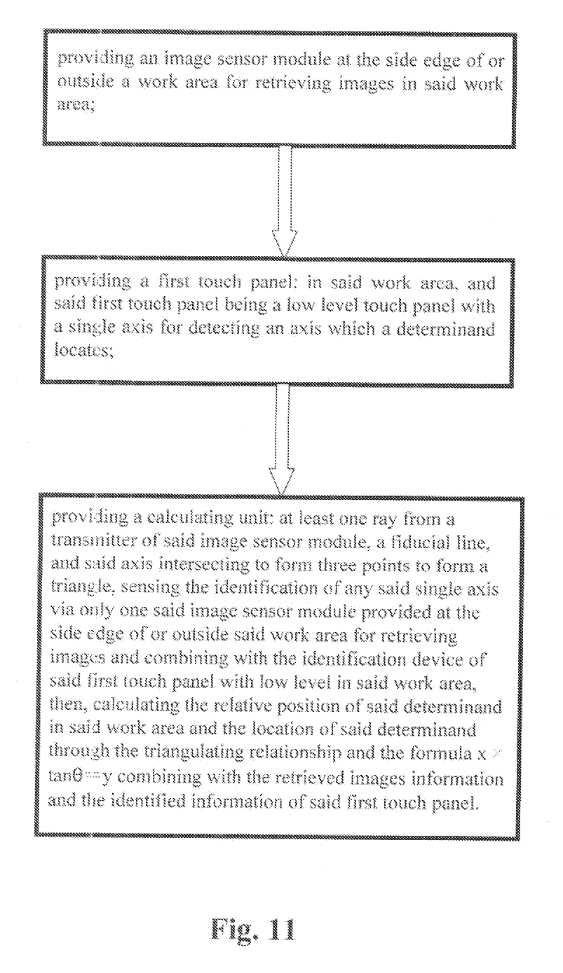

The present invention includes a device of identifying the position of determinant via combining optical image with single axis of touch panel, referring to FIG. 11, including:
an image sensor module (11) at a side of a work area (13) or outside the work area (13) for retrieving images in the work area (13);
a first touch panel (14) in the work area (13), and being a low level touch panel with a single axis for detecting an axis (L0) which a determinant (16) locates; and a calculating unit (15) having at least one ray (L1) from a transmitter (111) of an image sensor module (11), a predetermined fiducial line (L2), and an axis (L0) intersecting to form three points (P1) (P2) (P3) to form a triangle. Only one image sensor module (11) is provided at the side of the work area (13) or outside the work area (13) for retrieving images, and combines with the identification device of the first touch panel (14) with relatively low level in the work area (13) to sense the identification of any axis. Next is calculation of the relative position of the determinant (16) in the work area and the location of the determinant (16) through the triangulating relationship and the formula x×tan θ=y combining with the retrieved information and the identified information of the first touch panel.

A second touch panel (17) is at the bottom of the work area (13) senses the pressure when the determinant (16) pressing and connects to the first touch panel (14) via a connecting line (12) to achieve synchronous induction and output.

Image sensor module (11) at one side of the work area (13) or outside the work area (13) retrieves the images in the work area (13), the lens of the image sensor module (11) facing the work area (13), combines with the identification device of the first touch panel (14) provided at the work area (13), such as Infrared ray type, Resistive type, Capacitive type, Sonic type, Optical sensor type, or Voltage type touch panel, to sense the identification of any single axis, wherein the single axis is even one axis taken from two axes (X-axis and Y-axis crisscross to identify the input coordinate). The calculating unit (15): at least one ray (L1) from a transmitter (111) of the image sensor module (11), a predetermined fiducial line (L2), and the axis (L0) intersect to form three points (P1) (P2) (P3) to form a triangle. Only one image sensor module (11) is provided at one side edge of the work area (13) or outside the work area (13) for retrieving images, and combines with the identification device of first touch panel (14) with relatively low level in the work area (13) to sense the identification of any axis. Next is calculating the relative position of the determinant (16) in the work area according to the triangulating relationship and the formula x×tan θ=y combining with the information of the retrieved images and the identified information of the first touch panel. That is, calculating the relative position of the determinant (16) in the work area through the triangulating relationship, the formula x×tan θ=y, the information of the retrieved images, and combining the identified information of the first touch panel (14).

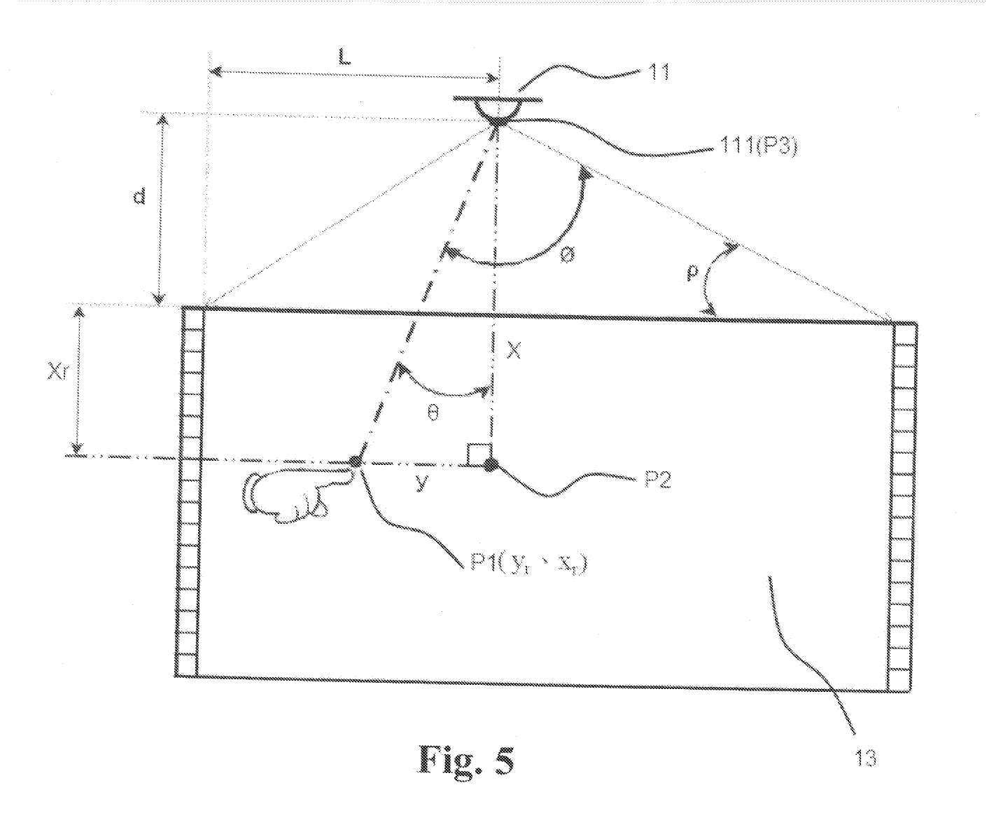

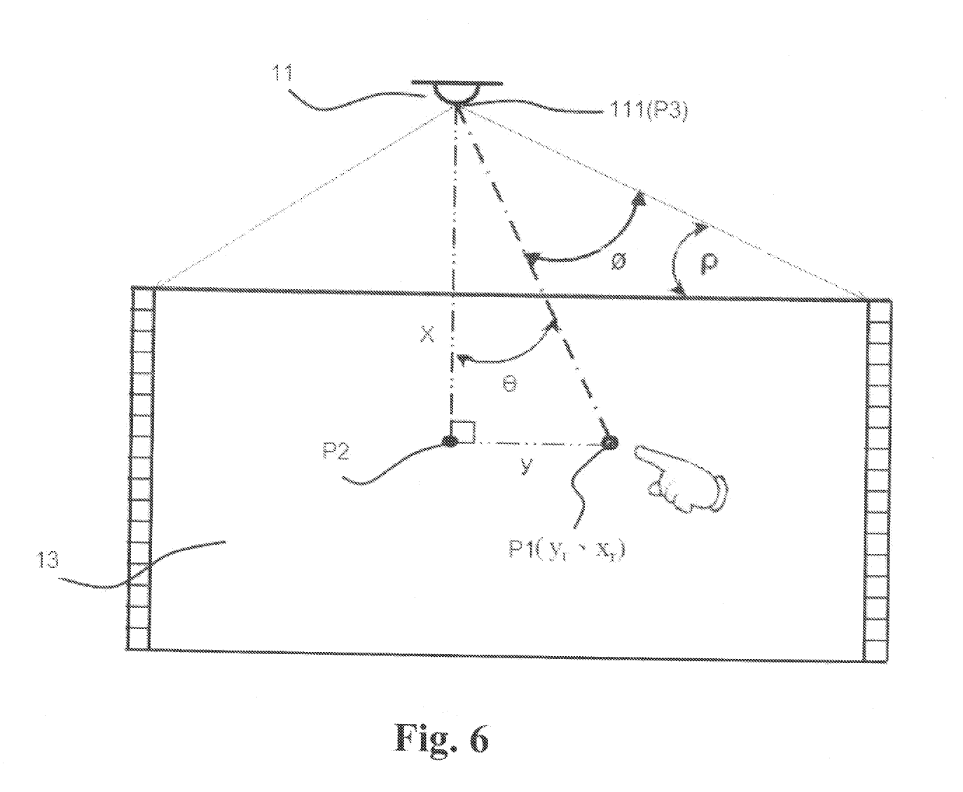

Referring to FIGS. 5 and 6, the present invention uses the formula x×tan θ=y, wherein x is the length of the line section of L2, y is the length of the line section of L0, and x=xᵣ+d (d≧0, x measured via other auxiliary equipments),

θ=|Ø+ρ−90°|,

if 0°≦Ø+ρ<90 [symbol] yᵣ=1+y;

if 90°≦Ø+ρ≦180° [symbol] yᵣ=1−y finally outputting the exact location (yᵣ, xᵣ),
P being the angle between the view boundary of the image sensor module (11) and the side of the work area (13);

└ being the angle calculated by the image sensor module (11) through the calculating unit (15).

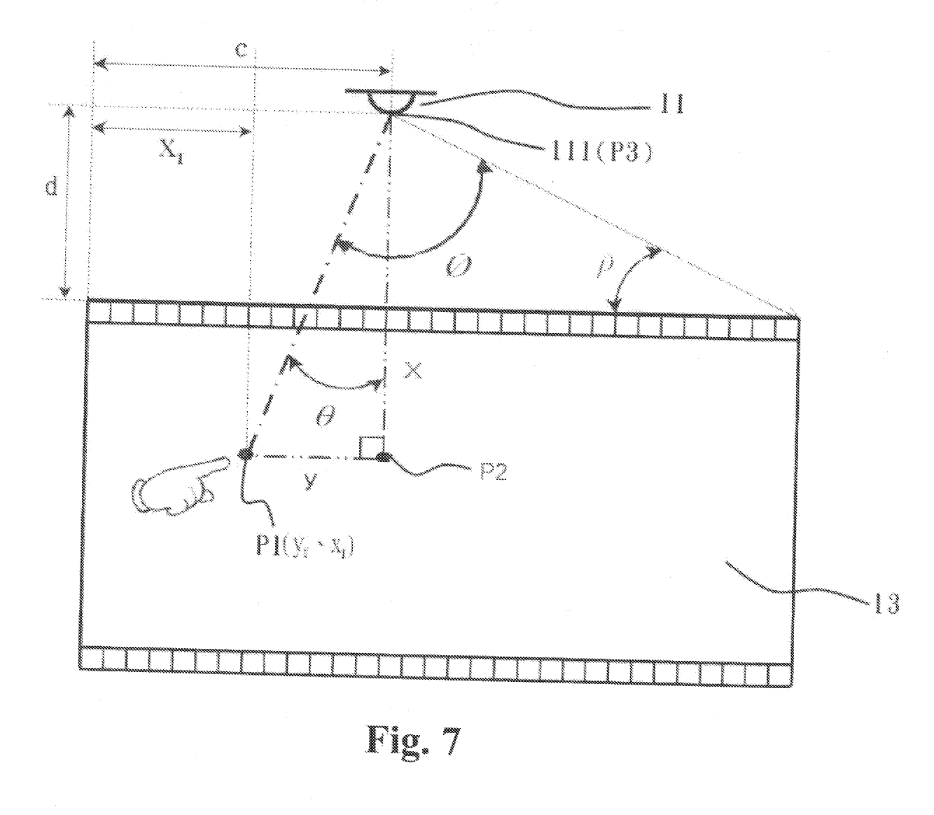

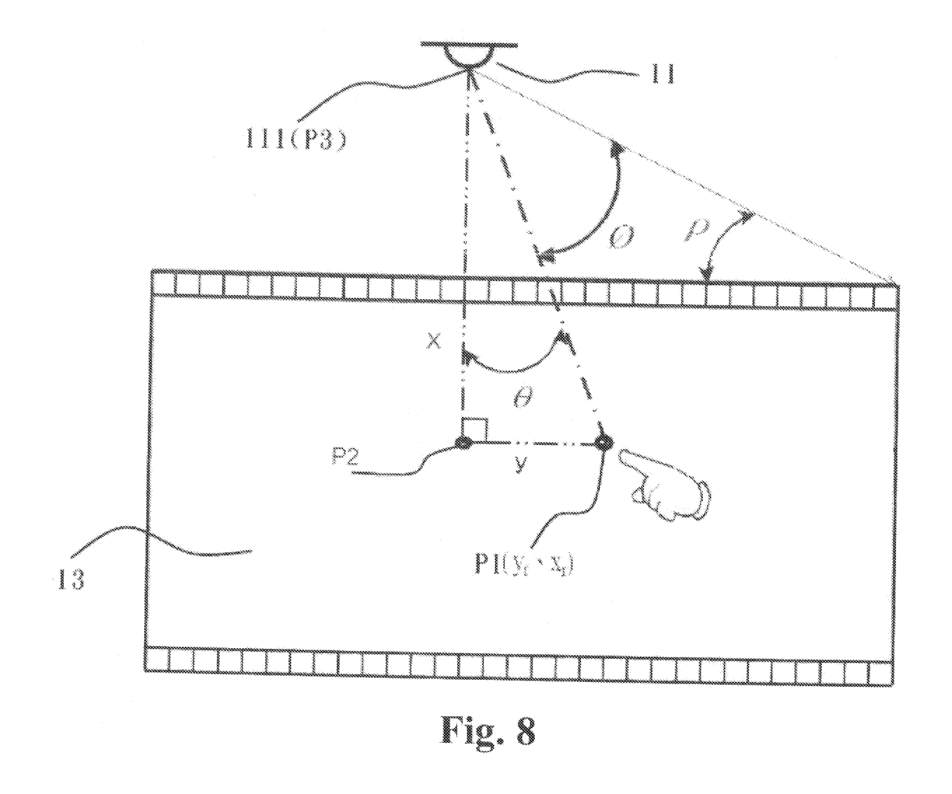

Referring to FIG. 7 and FIG. 8, the present invention uses the formula y=x×cot θ, wherein x is the length of line section of L2, y is the length of the line section of L0, and

θ=|Ø+ρ−90°|,yᵣ=y−dd≧0
x=|c−xᵣ|, x measured via other auxiliary equipments
finally outputting the exact location (yᵣ, xᵣ),
ρ being the angle between the view boundary of the image sensor module (11) and the side edge of the work area (13),
Ø being the angle calculated by the image sensor module (11) through the calculating unit (15).

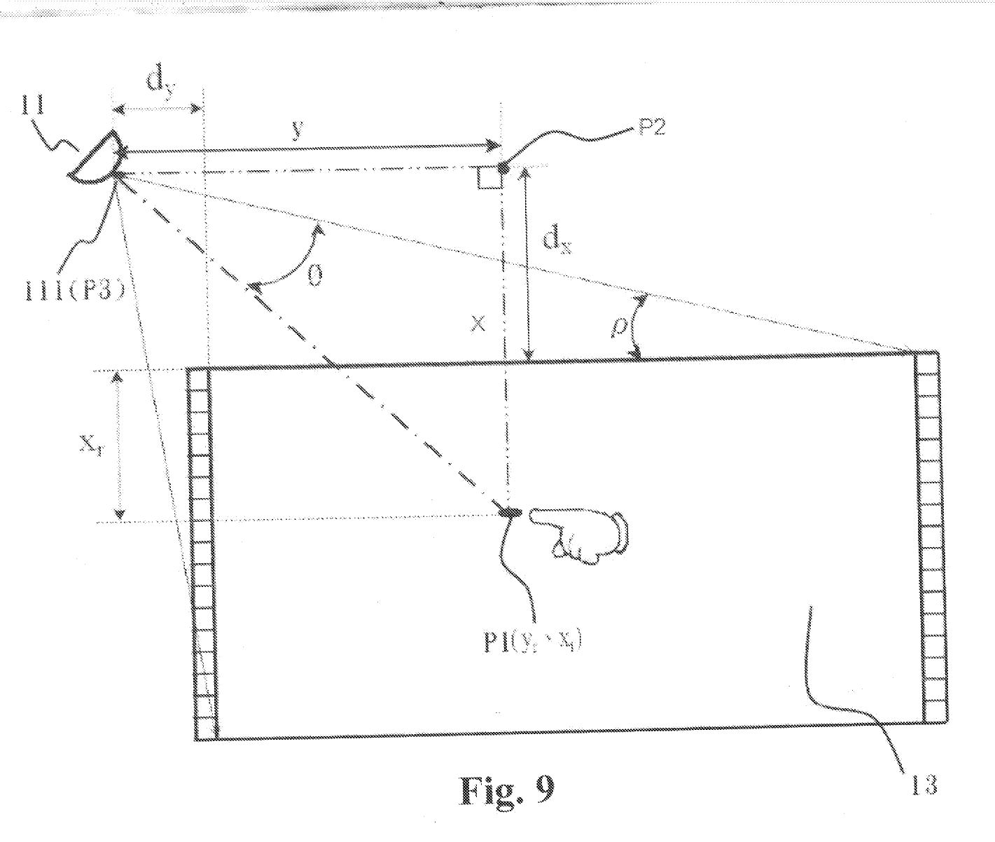

Referring to FIG. 9, the calculating principle of the present invention according to the third embodiment is interpreted.

To the formula y=x×cot(Ø+ρ) [symbol] yᵣ=y−d_{y} d_{y}≧0; x=xᵣ+dₓ dₓ≧0 x completed via other auxiliary equipments,
wherein x is the length of line section coincident with L2, y is the length of the line section coincident with L0, and
ρ being the angle between the view boundary of the image sensor module (11) and the side edge of the work area (13),
Ø being the angle calculated by the image sensor module (11) through the calculating unit (15),
finally outputting the exact location (yᵣ, xᵣ).

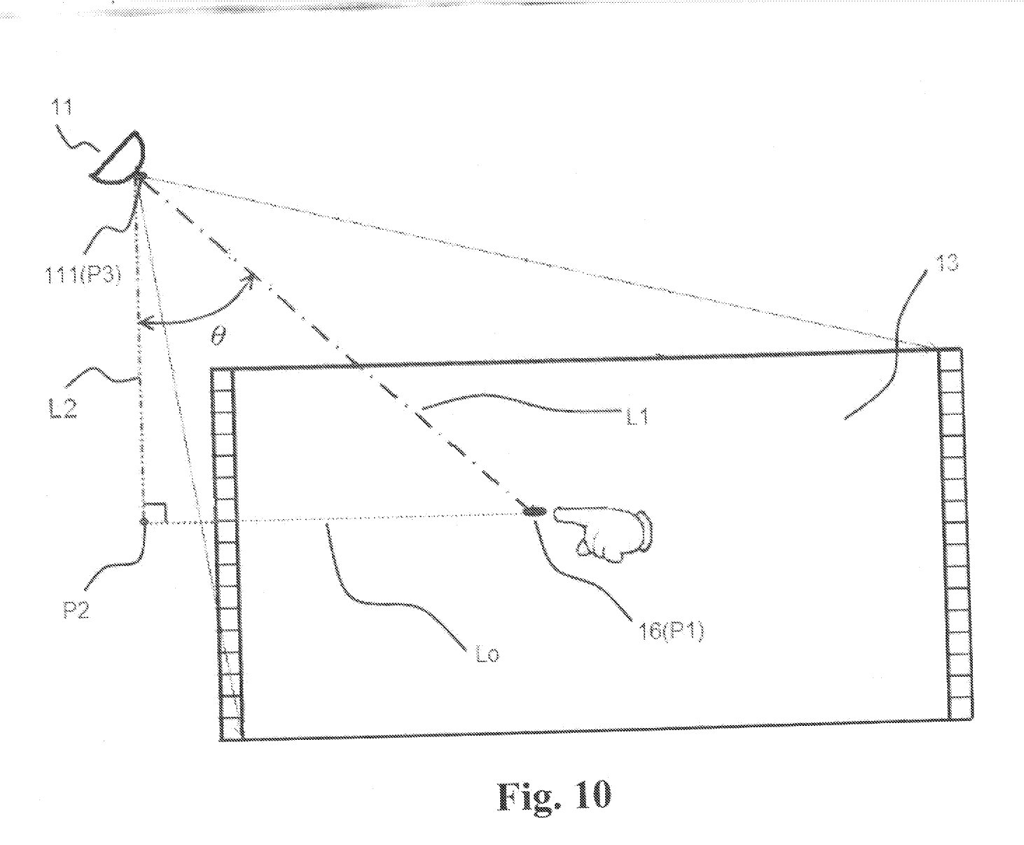

The image sensor module (11) may be provided at a large space outside the work area (13), and use different triangulating conversion relationships, as shown in FIG. 10. That is, at least one ray (L1) from the transmitter (111) of the image sensor module (11) connecting to the sensing axis (L0), and a ray (L2) defined as the fiducial line from the transmitter (111) of the image sensor module (11) and perpendicular to the axis (L0), then calculating the location of the determinant (16) through the triangulating relationship via a right-angled triangle formed by three lines (L0) (L1) (L2).

One skilled in the art will understand that the embodiment of the present invention as shown in the drawings and described above is exemplary only and not intended to be limiting.

The embodiments have been shown and described for the illustrating the functional and structural principles of the present invention. The person of ordinary skill in the art will appreciate that various changes may be made without departure from such the spirit and scope of the invention.

1-10. (canceled)

11. A device for identifying the position of a determinant via combining an optical image with a single axis of touch panel, comprising:
an image sensor module provided at the side of or outside a work area for retrieving images in said work area;
a first touch panel provided in said work area, which is a low level touch panel with a single axis which a determinant locates; and
a calculating unit with at least one ray from a transmitter of said image sensor module, a fiducial line, and said axis for intersecting to form a triangle, for sensing the identification of any said single axis via said image sensor module for retrieving images and combining with the identification device of said first touch panel, for then, calculating the relative position of said determinant in said work area through the triangulating relationship and the formula x×tan θ=y combining with the retrieved images and identified information from said first touch panel.

12. The device, as recited in claim 11, wherein a second touch panel is provided at the bottom of said work area for sensing pressure when said determinant pressing, and connects to said first touch panel via a connecting line to achieve synchronous induction and output.

13. The device, as recited in claim 11, wherein said calculating unit further includes a circuit board electrically connected to an image sensor unit in said image sensor module.

14. The device, as recited in claim 12, wherein said calculating unit further includes a circuit board electrically connected to an image sensor unit in said image sensor module.

15. The device, as recited in claim 11, wherein said image sensor module is a CCD image sensor module.

16. The device, as recited in claim 11, wherein said image sensor module is a CMOS image sensor module.

17. The device, as recited in claim 12, wherein said image sensor module is a CCD image sensor module.

18. The device, as recited in claim 12, wherein said image sensor module is a CMOS image sensor module.

19. The device, as recited in claim 14, wherein said image sensor module is a CCD image sensor module.

20. The device, as recited in claim 14, wherein said image sensor module is a CMOS image sensor module.

21. The device, as recited in claim 11, wherein said first touch panel is selected from a group consisting of an Infrared ray type touch panel, a Resistive type touch panel, a Capacitive type touch panel, a Sonic type touch panel, an Optical sensor type touch panel, and a Voltage type touch panel.

22. The device, as recited in claim 12, wherein said first touch panel is selected from a group consisting of an Infrared ray type touch panel, a Resistive type touch panel, a Capacitive type touch panel, a Sonic type touch panel, an Optical sensor type touch panel, and a Voltage type touch panel.

23. The device, as recited in claim 14, wherein said first touch panel is selected from a group consisting of an Infrared ray type touch panel, a Resistive type touch panel, a Capacitive type touch panel, a Sonic type touch panel, an Optical sensor type touch panel, and a Voltage type touch panel.

24. A method of identifying the position of determinant via combination with an optical image and a single axis of touch panel, including:
retrieving images in said work area by an image sensor module provided at the side of or outside a work area;
detecting an axis which a determinant locates by a first touch panel provided in said work area, wherein said first touch panel is a low level touch panel with a single axis for;
sensing an identification of any said single axis via only one said image sensor module and combining with said identification from said first touch panel by a calculating unit, such that at least one ray from a transmitter of said image sensor module, a fiducial line, and said axis intersect to form a triangle; and
calculating a relative position of said determinant in said work area and the location of said determinant through triangulation and the formula x×tan θ=y in response to retrieved images information and identified information from said first touch panel.

25. The method of claim 24, further comprising a step of sending pressure by a second touch panel is provided at the bottom of said work area when said determinant pressing, wherein said second touch panel is connected to said first touch panel via a connecting line to achieve synchronous induction and output.

26. The method of claim 24, wherein said image sensor module is a CCD image sensor module.

27. The method of claim 25, wherein said image sensor module is a CMOS image sensor module.

28. The method of claim 24, wherein said first touch panel is selected from a group consisting of an Infrared ray type touch panel, a Resistive type touch panel, a Capacitive type touch panel, a Sonic type touch panel, an Optical sensor type touch panel, and a Voltage type touch panel.

29. The method of claim 24, wherein said calculating unit includes a circuit board electrically connected to an image sensor unit provided in said image sensor module.

30. The method of claim 28, wherein said calculating unit includes a circuit board electrically connected to an image sensor unit provided in said image sensor module.
